(19) United States
(12) Patent Application Publication
(10) Pub. No.: US 2026/0262588 A1
(43) Pub. Date: Sep. 10, 2026

(54) METHOD AND SYSTEM FOR CULTIVATING A CROP

(71) Applicant: Priva Holding B.V., De Lier (NL)

(72) Inventors: Petrus Gerardus Hendrikus KAMP, Amersfoort (NL); Jan Johannes Wybe WESTRA, s'-Gravenzande (NL)

(21) Appl. No.: 19/491,283

(22) PCT Filed: Jun. 7, 2024
(86) PCT No.: PCT/NL2024/050303

§ 371 Date: Dec. 8, 2025

(30) Foreign Application Priority Data
Jun. 9, 2023 (NL) 2035063

(51) Int. Cl. A01G 27/00; A01G 9/24; A01G 27/02; G01N 27/06

(52) U.S. Cl. CPC A01G 27/003; A01G 9/247; G01N 27/06; A01G 27/005; A01G 27/02

(57) ABSTRACT

A method and system for cultivating a crop. A supply amount of a nutrient solution is supplied to the crop, the nutrient solution having a first electrical parameter indicative of an electrical conductivity of the supplied nutrient solution, and a supply parameter indicative of a nutrient supply to the crop is determined based on the supply amount and the first electrical parameter. A drainage amount of a drainage solution from the crop is obtained, a second electrical parameter indicative of an electrical conductivity of the drainage solution is measured, and a drainage parameter indicative of a nutrient drainage from the crop based on the drainage amount and the second electrical parameter is determined. A nutrient uptake parameter indicative of a nutrient uptake by the crop is determined based on a difference between the supply parameter and the drainage parameter.

### FIELD

The invention relates to a method and system for cultivating a crop.

### BACKGROUND

The cultivation of plants, for example in greenhouses or open fields, may involve the supply of water and nutrients to the crop. Photosynthesis is the driving process behind the development of the crop. In this process, light energy is converted into chemical energy contained in hydrocarbons, particularly sugars, with which the crop can develop. Development of the plant includes general growth of the crop as a whole, but also, for example, to fruit production and ripening, etc. The photosynthesis process thus relates to dry matter uptake processing and sequestration by the crop. The growth stage of a crop may largely determine its activity state, and therefore also the photosynthesis process. The activity state may vary over time, e.g. over the course of an hour, day, week, and season.

### SUMMARY

It is an aim to provide a method and system for cultivating a crop, particularly for enabling control over the cultivation of the crop.

An aspect provides a method for cultivating a crop, comprising supplying a supply amount of a nutrient solution to the crop, the nutrient solution having a first electrical parameter indicative of an electrical conductivity of the supplied nutrient solution, and determining a supply parameter indicative of a nutrient supply to the crop based on the supply amount and the first electrical parameter. The method also comprises obtaining a drainage amount of a drainage solution from the crop, measuring a second electrical parameter indicative of an electrical conductivity of the drainage solution, and determining a drainage parameter indicative of a nutrient drainage from the crop based on the drainage amount and the second electrical parameter. The method comprises determining a nutrient uptake parameter indicative of a nutrient uptake by the crop based on a difference between the supply parameter and the drainage parameter. It can hence be determined how much nutrients the crop has absorbed and fixated, e.g. to determine a state of the crop. The nutrient solution supplied to the plant may be water-based, with several nutrients added thereto. Nutrients may be dissolved in the nutrient solution. The concentration of nutrients, e.g. in the nutrient solution may be directly correlated to the electrical conductivity of the nutrient solution. The electrical parameters may hence be directly linked to a nutrient concentration in the fluid. For example, a high electrical conductivity of the nutrient solution may generally indicate a higher nutrient concentration, e.g. due to a higher ion content. The first and second electrical parameters may be expressed in units of Siemens per meter.

The composition of the nutrient solution may be known, and predetermined by the cultivator. The first electrical parameter may be measured for the nutrition solution, e.g. prior to being supplied to the crop. The second electrical parameter may be measured at or near a drainage line that receives drainage from the crop. The electrical parameters are indicative of the electrical conductivity of a fluid, and are thus a measure of its ability to conduct electricity. It will be appreciated that the electrical parameter may hence also be measured as an electrical resistance.

The first electrical parameter and the second electrical parameter may be directly linked to a nutrient concentration of the nutrient solution and the drainage solution respectively. In combination with the first and second amounts, a derived mass balance may be obtained. The nutrient uptake by the plant can hence be estimated based on a difference between the absolute supply and the absolute drainage of nutrients.

It may be desired to maintain the nutrient uptake of the crop as stable as possible, and have it change only gradually if so desired. A low nutrient uptake may for example indicate water-stress by the crop, as there may be insufficient water available for transport and uptake of the nutrients. A largely varying nutrient uptake may indicate stress of the crop, negatively influencing its development. The supply amount, and other environmental conditions, may hence be controlled to maintain a steady and gradual nutrient uptake parameter over time.

Optionally, the nutrient uptake parameter is indicative of a mass of nutrients taken up by the crop.

Optionally, the method comprises determining a mapping between a first set of parameters of a nutrient or a drainage solution, including an electrical parameter, and a composition of the nutrient solution, and determining a composition of the drainage solution based on the determined mapping and a second set of parameters including the second electrical parameter. The second set of parameters may also include the drainage amount. The mapping may be determined from known compositions of solutions. The first set of parameters may hence be known, or can be determined, e.g. measured. A characteristic could be determined between known compositions and their associated first set of parameters. This mapping could be used for determining the nutrient composition in the drainage fluid. The second set of parameters, including the second electrical parameter, can for example be mapped by the mapping, to obtain an estimate of the composition of the drainage solution. With the estimated composition of the drainage solution, and the composition of the nutrient solution supplied to the crop which may be known, or can be measured or determined using the mapping, it can hence be determined which specific nutrients, or class of nutrients, have and have not been absorbed by the crop, and in which amounts.

Optionally, the first set of parameters includes an acidity parameter indicative of an acidity of the solution.

Optionally, the method comprises measuring a second acidity parameter indicative of an acidity of the drainage solution. Optionally, the second set of parameters includes the second acidity parameter. Optionally, the second set of parameter includes one or more of a translucency parameter, a viscosity parameter, a temperature parameter, and a color parameter.

Optionally, the method comprises measuring a first acidity parameter indicative of an acidity of the supply solution.

Optionally, the method comprises analyzing, e.g. a sample of, the drainage solution for determining a composition of the drainage solution. The determined composition of the drainage solution can be compared to the, e.g. known or measured, nutrient solution supplied to the crop, for determining which specific nutrients have been absorbed by the crop, and in what amount.

Optionally, the supply parameter is determined as a product of the supply amount and the first electrical parameter, and/or wherein the drainage parameter is determined as a product of the drainage amount and the second electrical parameter. The supply and drainage amounts may be expressed in units of volume or mass, e.g. relative to leaf surface area of the crop. The first and second electrical parameters may be expressed in units of Siemens per meter, being assumed to directly link to a nutrient concentration. Multiplication of the supply and drainage amounts with respectably the first and second electrical parameters would yield a parameter that is indicative of a mass of nutrients, and which can be used to determine the nutrient uptake by the plant.

Optionally, the method comprises determining a change of the second electrical parameter of the drainage solution over a period of time, and generating a warning signal in case the change of the second electrical parameter exceeds a predetermined threshold. If a sudden and sharp rise of the second electrical parameter is observed, that may be sign of decreased nutrient uptake after a previous supply event. The unabsorbed nutrients may hence have remained in the crop substrate. As the crop has absorbed water from the substrate, the nutrient concentration in the substrate has increased, compared to the supply solution. During a next supply event, the nutrients in the substrate may wash out and be drained from the crop, hence sharply increasing the nutrient concentration in the drainage solution, which can be detected from the measured second electrical parameter. A large change in the electrical parameter may hence indicate a large change in nutrient concentration, and may be sign that the crop in stress, particularly that the crop has insufficient water available and/or that a temperature of the crop is too high for optimal nutrient uptake.

Optionally, the method comprises increasing the first amount of nutrient solution supplied to the crop in case the change of the second electrical parameter exceeds the predetermined threshold.

Optionally, the nutrient solution is batch-wise supplied to the crop. The crop may be supplied with the nutrient solution at regular intervals, particularly during day time. The batch volume may be adjusted from supply event to supply event, e.g. depending on a state of the crop.

Optionally, for each batch of nutrient solution supplied to the crop, a respective supply parameter is determined.

Optionally, the method comprises determining a cumulative supply parameter indicative of a nutrient supply to the crop over a predetermined time period by summing the supply parameters of a plurality of supplied batches within said time period. The time period may for example span a course of several hours, or one or more days.

Optionally, the drainage solution from the crop is batch-wise collected.

Optionally, for each batch of collected drainage solution, a respective drainage parameter is determined.

Optionally, the method comprises determining a cumulative drainage parameter indicative of a nutrient drainage from the crop over a predetermined time period by summing the drainage parameters for a plurality of collected drainage batches within said time period.

Optionally, the method comprises determining a water uptake parameter indicative of an amount of water taken up by the crop as a difference between the supply amount of nutrient solution and the drainage amount of drainage solution.

Optionally, the method comprises measuring an irradiance parameter indicative of an amount of light irradiation the crop is exposed to, and determining an evaporation parameter indicative of a water evaporation rate of the crop based on the measured irradiance parameter. The light irradiation may be a measure for the transpiration activity of the crop. The irradiance parameter may be expressed as a ratio or percentage of the water uptake by the crop that is transpired by the crop. The irradiance parameter may be related to the crop's leaf surface area. Optionally, the supply amount of nutrient solution to the crop may be adjusted based on the measured irradiance parameter. For example, the supply amount may be adjusted proportional to the irradiance parameter.

Optionally, the uptake parameter is determined on the basis of a determined cumulative irradiation parameter indicative of a total irradiation the crop has been exposed to in a period of time, such as in the course of a day. From the light irradiation, e.g. photon flux, light intensity or power per unit (leaf) surface area, the total amount of light energy that the crop has been exposed to in the time interval can be determined. This can be used for determining photosynthetic activity of the crop, and hence an associated nutrient uptake. The uptake parameter may hence be determined using the cumulative irradiation parameter.

Optionally, the method comprises determining a water fixation parameter indicative of an amount of water fixated by the crop based on a difference between the water uptake parameter and the water evaporation parameter.

Optionally, the method comprises adjusting the supply amount of the nutrient solution based on one or more of the water uptake parameter, the evaporation parameter, and the water fixation parameter.

Optionally, the nutrient uptake parameter is determined only after a first non-zero drainage amount is obtained after supplying the nutrient solution. Initially, the supply of nutrient solution to the plant is absorbed by the substrate on which the crop is grown, without there being any drainage. Once the substrate is saturated, a drainage of fluid may be obtained upon supply of more nutrient solution.

Optionally, the nutrient solution supplied to the crop is such that the first electrical parameter is maintained gradual over time. A constant or gradually changing second electrical parameter may indicate a steady non-variable nutrient concentration in the drainage solution, and hence steady non-variable water and nutrient uptake by the crop. Such condition may be favorable for the crop's development.

Optionally, the supply amount of nutrient solution is adjusted over time in dependence on the determined nutrient uptake parameter.

Optionally, a composition of the nutrient solution supplied to the crop is maintained constant over time. Hence, only the supply amount may be adjusted over time, while the nutrient concentration is kept constant.

Optionally, the supply amount of nutrient solution is adjusted over time in dependence of an activity state of the crop.

Optionally, the supply amount of nutrient solution to the crop is dependent on the crop-type of the crop.

Optionally, the supply amount of nutrient solution is zero during night time. During the night, the substrate may be left dry out to allow aeration of the crop's root system.

Another aspect provides a crop cultivation system, for example arranged for executing a method as described herein. The system comprises a nutrient solution reservoir fluidly connected to a nutrient solution supply line arranged for supplying a supply amount of a nutrient solution to the crop, and drainage line arranged for draining a drainage amount of a drainage solution from the crop. The system comprises a first sensor arranged for measuring a first electrical parameter of the nutrient solution supplied to the crop indicative of an electrical conductivity of the nutrient solution and a second sensor arranged for measuring a second electrical parameter of the drainage solution drained from the crop indicative of an electrical conductivity of the drainage solution. The system comprises a processing device configured for determining, based on the supply amount and the first electrical parameter, a supply parameter indicative of a nutrient supply to the crop; determining, based on the drainage amount and the second electrical parameter, a drainage parameter indicative of a nutrient drainage from the crop; and determining a nutrient uptake parameter indicative of a nutrient uptake by the crop based on a difference between the supply parameter and the drainage parameter.

Another aspect provides a processing device for a crop cultivation system, such as described herein. The processing device being configured for receiving a first sensor signal associated with a supply amount of nutrient solution supplied to the crop and a first electrical parameter indicative of an electrical conductivity of the nutrient solution; receiving a second sensor signal associated with a drainage amount of drainage solution drained from the crop and a second electrical parameter indicative of an electrical conductivity of the drainage solution; determining, based on the supply amount and the first electrical parameter, a supply parameter indicative of a nutrient supply to the crop; determining, based on the drainage amount and the second electrical parameter, a drainage parameter indicative of a nutrient drainage from the crop; and determining a nutrient uptake parameter indicative of a nutrient uptake by the crop based on a difference between the supply parameter and the drainage parameter.

It will be appreciated that the methods described herein may include computer-implemented steps. Embodiments may comprise computer apparatus, wherein processes are performed in the computer apparatus. The invention also extends to computer programs, particularly computer programs on or in a carrier, adapted for putting the invention into practice. The program may be in the form of source or object code or in any other form suitable for use in the implementation of the processes according to the invention. The carrier may be any entity or device capable of carrying the program. For example, the carrier may comprise a storage medium, such as a ROM, for example a semiconductor ROM or hard disk. Further, the carrier may be a transmissible carrier such as an electrical or optical signal which may be conveyed via electrical or optical cable or by radio or other means, e.g. via the internet or cloud.

Some embodiments may be implemented, for example, using a machine or tangible computer-readable medium or article which may store an instruction or a set of instructions that, if executed by a machine, may cause the machine to perform a method and/or operations in accordance with the embodiments.

Various embodiments may be implemented using hardware elements, software elements, or a combination of both. Examples of hardware elements may include processors, microprocessors, circuits, application specific integrated circuits (ASIC), programmable logic devices (PLD), digital signal processors (DSP), field programmable gate array (FPGA), logic gates, registers, semiconductor device, microchips, chip sets, et cetera. Examples of software may include software components, programs, applications, computer programs, application programs, system programs, machine programs, operating system software, mobile apps, middleware, firmware, software modules, routines, subroutines, functions, computer implemented methods, procedures, software interfaces, application program interfaces (API), methods, instruction sets, computing code, computer code, et cetera.

It will be appreciated that any of the aspects, features and options described herein can be combined. It will particularly be appreciated that any of the aspects, features and options described in view of the method apply equally to the system and device, and vice versa.

### BRIEF DESCRIPTION OF THE DRAWINGS

Embodiments of the present invention will now be described in detail with reference to the accompanying drawings in which:

FIG. 1 shows a schematic example of crop cultivation system;

FIG. 2 shows a schematic example a measurement data on a drainage solution.

### DETAILED DESCRIPTION

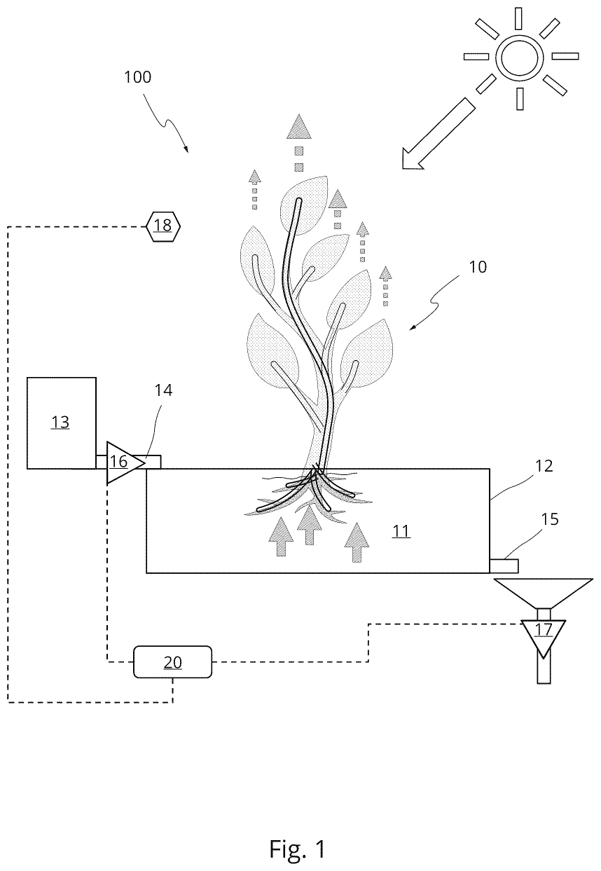

FIG. 1 shows a schematic example of system 100 for cultivating a crop 10. The crop 10 is cultivated on a substrate 11, here held by a container 12. The system 100 comprises a nutrient solution reservoir 13 fluidly connected to a nutrient solution supply line 14 arranged for supplying a nutrient solution to the crop 10. A drainage line 15 is arranged for draining a drainage solution from the crop. The system 100 comprises a first sensor unit 16 arranged for measuring a first electrical parameter of the nutrient solution supplied to the crop indicative of an electrical conductivity of the nutrient solution. The first sensor unit 16 is in this example also configured for measuring a flow of nutrient solution supplied to the crop 10. The first sensor unit 16 may optionally also be arranged to measure other properties of the nutrient solution, such as one or more of a temperature, a viscosity, a color, and a translucency. The system 100 also comprises a second sensor unit 17 arranged for measuring a second electrical parameter of the drainage solution drained from the crop indicative of an electrical conductivity of the drainage solution. Here, the second sensor unit 17 is also configured for measuring a flow of drainage solution drained from the crop 10. The second sensor unit 17 may optionally also be arranged to measure other properties of the nutrient solution, such as one or more of a temperature, a viscosity, a color, and a translucency. The system 100, here, also comprises an irradiation sensor 18, arranged for measuring a light irradiance.

The system comprises a processing device 20. The processing device 20 being configured for receiving a first sensor signal form the first sensor unit 16 associated with a supply amount of nutrient solution supplied to the crop and a first electrical parameter indicative of an electrical conductivity of the nutrient solution. The processing device 20 is also arranged for receiving a second sensor signal from the second sensor unit 17 associated with a drainage amount of drainage solution drained from the crop and a second electrical parameter indicative of an electrical conductivity of the drainage solution.

The processing unit 20 is arranged for determining, based on the supply amount and the first electrical parameter, a supply parameter indicative of a nutrient supply to the crop. The processing unit 20 is also arranged for determining, based on the drainage amount and the second electrical parameter, a drainage parameter indicative of a nutrient drainage from the crop. Based on a difference between the supply parameter and the drainage parameter, the processing unit 20 is arranged for determining a nutrient uptake parameter indicative of a nutrient uptake by the crop.

It can hence be determined how much nutrients the crop 10 has absorbed and fixated, e.g. to determine a state of the crop. The nutrient solution supplied to the plant may be water-based, with several nutrients added thereto. Nutrients may be dissolved in the nutrient solution. The concentration of nutrients, e.g. in the nutrient solution may be directly correlated to the electrical conductivity of the nutrient solution. The electrical parameters may hence be directly linked to a nutrient concentration in the fluid. For example, a high electrical conductivity of the nutrient solution may generally indicate a higher nutrient concentration, e.g. due to a higher ion content. The first and second electrical parameters may be expressed in units of Siemens per meter.

The composition of the nutrient solution may be known, and predetermined by the cultivator. The first electrical parameter may be measured for the nutrition solution, e.g. prior to being supplied to the crop. The second electrical parameter may be measured at or near a drainage line that receives drainage from the crop. The electrical parameters are indicative of the electrical conductivity of a fluid, and are thus a measure of its ability to conduct electricity. It will be appreciated that the electrical parameter may hence also be measured as an electrical resistance.

The first electrical parameter and the second electrical parameter may be directly linked to a nutrient concentration of the nutrient solution and the drainage solution respectively. In combination with the first and second amounts, a derived mass balance may be obtained. The nutrient uptake by the plant can hence be estimated based on a difference between the absolute supply and the absolute drainage of nutrients.

It may be desired to maintain the nutrient uptake of the crop as stable as possible, and have it change only gradually if so desired. A low nutrient uptake may for example indicate water-stress by the crop, as there may be insufficient water available for transport and uptake of the nutrients. A largely varying nutrient uptake may indicate stress of the crop, negatively influencing its development. The supply amount, and other environmental conditions, may hence be controlled to maintain a steady and gradual nutrient uptake parameter over time.

In this example, the supply parameter is determined as a product of the supply amount and the first electrical parameter, and the drainage parameter is determined as a product of the drainage amount and the second electrical parameter. In an example, a supply amount of 3.7 liter is supplied to the crop. It is measured, by the first sensor unit 16, that the first electric conductivity parameter is 2.8 milli-Siemens per meter. A drain is detected at the drainage line 15. The drainage amount, measured by the second sensor unit 17, is 0.9 liter, and the second electrical parameter associated with the drainage solution is 3.5 milli-Siemens per meter. The supply parameter is determined as the product of the supply amount and the first electrical parameter, here 3.7 times 2.8, yielding a supply parameter value of 10.4. The drainage parameter is determined as the product of the drainage amount and the second electrical parameter, here 0.9 times 3.5, yielding a drainage parameter value of 2.6. The uptake parameter is calculated as the difference between the supply parameter and the drainage parameter, here yielding a value 7.8. The supply, drainage and uptake parameters may be considered a mass-derivative parameter, being directly linked to respectively a nutrient mass supply, drainage and uptake. Environmental conditions of the crop 10 may be controlled in such way as to maintain the uptake parameter substantially constant and gradually changing. The supply amount of nutrient solution can particularly be controlled, based on the uptake parameter.

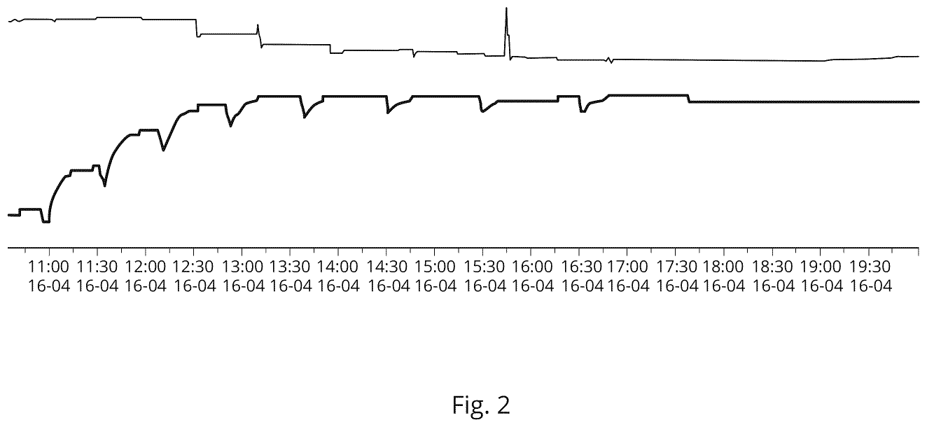

FIG. 2 shows an example of measurement data of the second sensor unit 17. The lower line shows a cumulative drainage amount measurement over the course of a day. The upper line shows measurement data of the electrical parameter of the drainage solution over the course of the day. It can be seen in FIG. 2 that the drainage is batch-wise observed, corresponding to a batch-wise supply of nutrient solution to the crop. It can further be observed that that the drainage amount per supply batch decreases during the day, indicative of an increased water uptake by the crop. A constant second electrical parameter may indicate an proportional uptake of nutrients. The electrical parameter, indicating the electrical conductivity of the drainage solution, is seen to initially slightly decrease, to eventually substantially stabilize. At approximately between 15:00 and 16:00 in the afternoon, however, a spike in the electrical parameter measurement is observed. This spike indicates a sudden high electrical conductivity of the drainage solution, and hence a sudden high concentration of nutrients in the drainage solution. This may be a sign that a relatively large amount nutrients has washed out from the substrate, which nutrients have accordingly not been absorbed by the crop. It may be concluded therefrom that the crop may have had water-stress in the past, as the crop appears to have absorbed much water but only a small amount of nutrients. If such large change is observed from the measurements of the second electrical parameter, the supply amount of nutrient solution may be adjusted accordingly. Also other environmental conditions of the crop may be adjusted, such as a light irradiance, a temperature, and a carbon dioxide concentration of the ambient air.

Herein, the invention is described with reference to specific examples of embodiments of the invention. It will, however, be evident that various modifications and changes may be made therein, without departing from the essence of the invention. For the purpose of clarity and a concise description features are described herein as part of the same or separate embodiments, however, alternative embodiments having combinations of all or some of the features described in these separate embodiments are also envisaged.

However, other modifications, variations, and alternatives are also possible. The specifications, drawings and examples are, accordingly, to be regarded in an illustrative sense rather than in a restrictive sense.

In the claims, any reference signs placed between parentheses shall not be construed as limiting the claim. The word ‘comprising’ does not exclude the presence of other features or steps than those listed in a claim. Furthermore, the words ‘a’ and ‘an’ shall not be construed as limited to ‘only one’, but instead are used to mean ‘at least one’, and do not exclude a plurality. The mere fact that certain measures are recited in mutually different claims does not indicate that a combination of these measures cannot be used to an advantage.

1. A method for cultivating a crop, comprising:
supplying a supply amount of a nutrient solution to the crop, the nutrient solution having a first electrical parameter indicative of an electrical conductivity of the supplied nutrient solution, and determining a supply parameter indicative of a nutrient supply to the crop based on the supply amount and the first electrical parameter;
obtaining a drainage amount of a drainage solution from the crop, measuring a second electrical parameter indicative of an electrical conductivity of the drainage solution, and determining a drainage parameter indicative of a nutrient drainage from the crop based on the drainage amount and the second electrical parameter; and
determining a nutrient uptake parameter indicative of a nutrient uptake by the crop based on a difference between the supply parameter and the drainage parameter.

2. The method according to claim 1, wherein the nutrient uptake parameter is indicative of a mass of nutrients taken up by the crop.

3. The method according to claim 1, comprising determining a mapping between a first set of parameters of a nutrient or a drainage solution, including an electrical parameter, and a composition of the nutrient solution, and determining a composition of the drainage solution based on the determined mapping and a second set of parameters including the second electrical parameter.

4. The method according to claim 1, wherein the supply parameter is determined as a product of the supply amount and the first electrical parameter, and/or wherein the drainage parameter is determined as a product of the drainage amount and the second electrical parameter.

5. The method according to claim 1, determining a change of the second electrical parameter of the drainage solution over a period of time, and generating a warning signal in case the change of the second electrical parameter exceeds a predetermined threshold.

6. The method according to claim 5, comprising increasing the first amount of nutrient solution supplied to the crop in case the change of the second electrical parameter exceeds the predetermined threshold.

7. The method according to claim 1, wherein the nutrient solution is batch-wise supplied to the crop.

8. The method according to claim 7, wherein for each batch of nutrient solution supplied to the crop, a respective supply parameter is determined.

9. The method according to claim 8, comprising determining a cumulative supply parameter indicative of a nutrient supply to the crop over a predetermined time period by summing the supply parameters of a plurality of supplied batches within said time period.

10. The method according to claim 1, wherein the drainage solution from the crop is batch-wise collected.

11. The method according to claim 10, wherein for each batch of collected drainage solution, a respective drainage parameter is determined.

12. The method according to claim 11, comprising determining a cumulative drainage parameter indicative of a nutrient drainage from the crop over a predetermined time period by summing the drainage parameters for a plurality of collected drainage batches within said time period.

13. The method according to claim 1, comprising determining a water uptake parameter indicative of an amount of water taken up by the crop as a difference between the supply amount of nutrient solution and the drainage amount of drainage solution.

14. The method according to claim 1, comprising measuring an irradiance parameter indicative of an amount of light irradiation the crop is exposed to, and determining an evaporation parameter indicative of a water evaporation rate of the crop based on the measured irradiance parameter.

15. The method according to claim 13, comprising determining a water fixation parameter indicative of an amount of water fixated by the crop based on a difference between the water uptake parameter and a water evaporation parameter.

16. The method according to claim 13, comprising adjusting the supply amount of nutrient solution based on one or more of the water uptake parameter, an evaporation parameter, and a water fixation parameter.

17. The method according to claim 1, wherein the nutrient uptake parameter is determined only after a first non-zero drainage amount is obtained after supplying the nutrient solution.

18. The method according to claim 1, wherein the nutrient solution supplied to the crop is such that the first electrical parameter is maintained gradual over time.

19. The method according to claim 1, wherein the supply amount of nutrient solution is adjusted over time in dependence on the determined nutrient uptake parameter.

20. (canceled)

21. (canceled)

22. (canceled)

23. (canceled)

24. A crop cultivation system, comprising nutrient solution reservoir fluidly connected to a nutrient solution supply line arranged for supplying a supply amount of a nutrient solution to the crop, and drainage line arranged for draining a drainage amount of a drainage solution from the crop,
wherein the system comprises a first sensor arranged for measuring a first electrical parameter of the nutrient solution supplied to the crop indicative of an electrical conductivity of the nutrient solution and a second sensor arranged for measuring a second electrical parameter of the drainage solution drained from the crop indicative of an electrical conductivity of the drainage solution, and
a processing device configured to:
determine, based on the supply amount and the first electrical parameter, a supply parameter indicative of a nutrient supply to the crop:
determine, based on the drainage amount and the second electrical parameter, a drainage parameter indicative of a nutrient drainage from the crop; and
determine a nutrient uptake parameter indicative of a nutrient uptake by the crop based on a difference between the supply parameter and the drainage parameter.

25. (canceled)
